(19) United States
(12) Patent Application Publication
(10) Pub. No.: US 2007/0298741 A1
(43) Pub. Date: Dec. 27, 2007

(54) Multi radio/multi channel base station for wireless networks

(76) Inventors: Kevin A. Harnist, Huntley, IL (US); James Pristas, Barrington, IL (US)

Correspondence Address: CARLSON, GASKEY & OLDS, P.C., 400 WEST MAPLE ROAD, SUITE 350, BIRMINGHAM, MI, 48009, US

(21) Appl. No.: 11/473,088

(22) Filed: Jun. 22, 2006

(51) Int. Cl. H04B 1/18

(52) U.S. Cl. 455/185.1

(57) ABSTRACT

A local area network (LAN) includes a computer processing unit (CPU) located within an aircraft cabin. A plurality of radios is connected to the CPU and to a radio frequency (RF) combiner and splitter. The RF combiner and splitter allows for each of the radios to transmit and receive common information over a plurality of different channels. As the number of users within the LAN increases additional radios can be connected to the CPU and the RF combiner and splitter for increased signal coverage and capacity.

### BACKGROUND OF THE INVENTION

The invention generally relates to an improved arrangement of radios in a local area network. More particularly, this invention relates to associating a plurality of radios with a base station for a local area network.

Typically, local area networks (LANs) have multiple users connected to a computer processing unit (CPU). The CPU may also be connected to the Internet to provide access for each individual user. Wireless communications among users in a LAN is increasingly popular. However, each user must still be connected to the LAN in some manner. In the case of wireless communications radios are utilized to transmit and receive signals from the users.

Prior art systems include multiple CPUs each having a radio. Each radio has limited capacity to carry signals between the CPU and the users. Thus, to provide the processing capability required for all the LAN users additional CPUs and radios are required to provide the capacity to transmit the user signals.

Advances in technology and communications have recently allowed for wireless communications in aircraft. However, adding CPUs to provide the network capacity required adds weight and takes additional space. Also, having separate CPUs provides decentralized control of the radios, since each CPU is responsible for controlling its radio.

Thus, an improved arrangement for providing signal capacity in a LAN without requiring additional CPUs is desirable.

### SUMMARY OF THE INVENTION

An example wireless local area network according to this invention provides increased signal capacity for a network computer processing unit.

An aircraft cabin includes a local area network (LAN) to allow connection among aircraft passengers without requiring a wired connection. A computer processing unit (CPU) is located within the aircraft cabin to provide a base station for the LAN. A plurality of radios is connected to the CPU to transmit signals to and from each of the users. Each of the radios is connected to a radio frequency (RF) combiner and splitter. The RF combiner and splitter allows for each of the radios to transmit and receive common information over a plurality of different channels to provide broader coverage of available frequencies. As the number of users within the LAN increases, additional radios can be added for increased signal coverage and capacity.

Accordingly, the local area network of this invention uses a common CPU having multiple radios to provide increased signal capacity without requiring complex wiring and hardware to connect the radios to the signal source.

These and other features of the present invention can be best understood from the following specification and drawings, the following of which is a brief description.

### BRIEF DESCRIPTION OF THE DRAWINGS

FIG. 1 is a view of a portion of an aircraft cabin having an example local area network of the present invention

FIG. 2 is a schematic of the example local area network of the present invention;

FIG. 3 is a schematic of an example local area network of the prior art; and

FIG. 4 is a schematic of another example local area network according to the present invention having the same coverage as the prior art example network.

### DETAILED DESCRIPTION OF THE PREFERRED EMBODIMENT

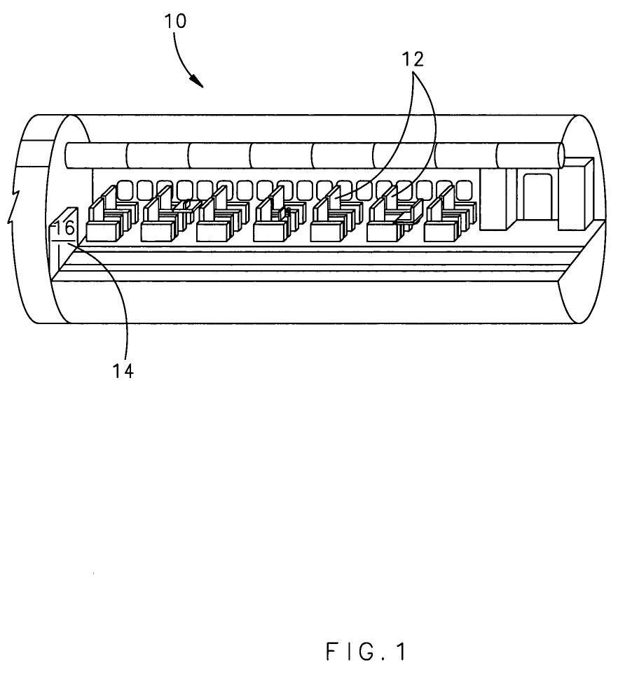

FIG. 1 is a view of a portion of an aircraft cabin 10 having a plurality of seats 12. Each seat 12 represents a possible location that must communicate with a local area network (LAN) 14 within the aircraft cabin 10. The LAN 14 network may be used to allow aircraft passengers to connect to the Internet without requiring a wired connection. A computer processing unit (CPU) 16 is located within the aircraft cabin 10 to provide a base station for the LAN 14. The CPU 16 may include a satellite uplink to connect the aircraft cabin 10 with exterior communications. Alternately, the wireless LAN 14 may allow aircraft passengers to connect to an internal communications system, such as a broadband signal for an aircraft film library, without requiring a wired connection.

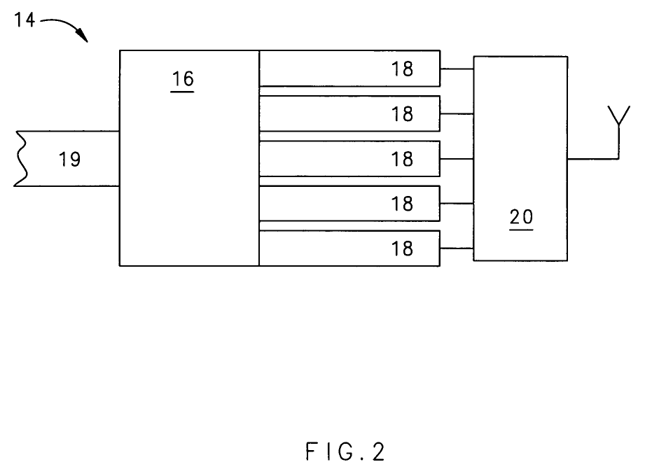

FIG. 2 illustrates a LAN 14 for use in the aircraft cabin 10. A plurality of radios 18 is connected to the CPU 16 to transmit signals to from each of the users. Each of the radios are directly connected to the CPU 16 through a wired connection. The CPU 16 may be connected to an Ethernet 19 or other connection. Each radio 18 includes a radio frequency (RF) transmitter and receiver 23. Additionally, a RF combiner and splitter 20 is connected to each of the radios 18 as well. The connection between the RF combiner and splitter 20 and the radios 18 is also a wired connection. Because of the individual connection between each of the radios 18 and the RF combiner and splitter 20 the system can transmit and receive the information over a plurality of different channels. Each of the radios 18 transmits at least one RF signal. The RF combiner and splitter 20 allows for each of the radios to transmit information from the CPU 16 by splitting the outgoing signal from the CPU 16 to transmit over a plurality of different channels, associated with each of the radios 18. The RF combiner and splitter 20 also combines the incoming signal from the radios 18 to be sent to the common CPU 16.

Preferably, each of the radios 18 transmit signals over different channels to provide a broader coverage of available frequencies. By utilizing the RF combiner and splitter 20 multiple radios 18 can be connected to a single CPU 16. As the number of users within the LAN 14 increases, signal speed may slow. Additional radios 18 can be added for increased signal coverage and capacity to maintain a desired processing speed. Because all of the necessary radios 18 can be connected to a common CPU 16, the need for additional CPUs 16 and wiring between them is eliminated reducing the size, weight and complexity of the LAN 14.

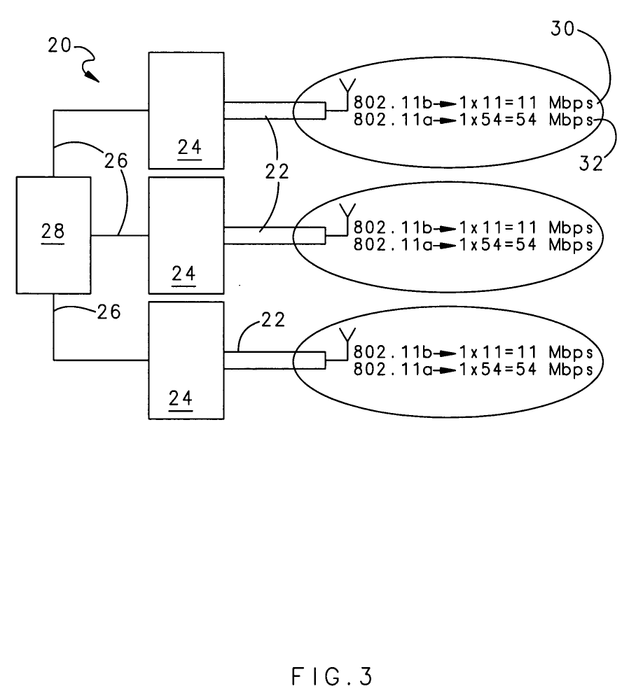

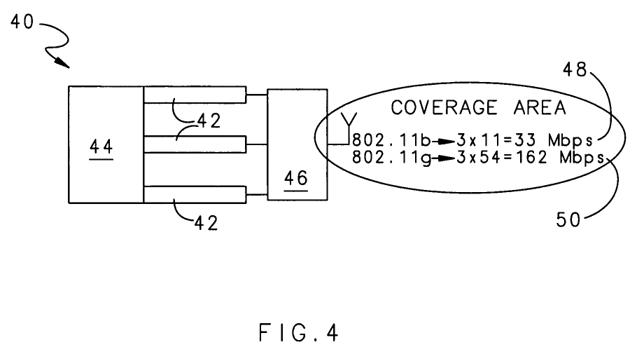

An example illustrating the processing capacity of a prior art system, and an example system of the present invention are shown in FIGS. 3 and 4. FIG. 3 illustrates a prior art LAN 20 having three radios 22. Each radio 22 is connected to a separate one of three base stations 24 which each has a wired connection 26 to an Ethernet 28 or other wired network. The three base stations 24 are typically located in separate areas through the aircraft cabin 10. Each radio 22 transmits a first signal 30, say at eleven megabytes per second (Mbps) and a second signal 32, say at fifty-four Mbps. The total coverage area for the prior art LAN 20 is thirty-three Mbps for the first signal 30 and one hundred and sixty-two Mbps for the second signal 32. To provide additional coverage for the LAN 20 a fourth base station 24 and radio 22 must be added.

FIG. 4 illustrates an inventive LAN 40 having three radios 42, like the prior art LAN 20. Each radio is connected to a common main base station 44. An RF combiner and splitter 46 is connected to each of the three radios 42. Each radio 42 transmits a first signal 48, say at eleven Mbps and a second signal 50, say at fifty-four Mbps. The total coverage area for the example LAN 40 is thirty-three Mbps for the first signal 30 and 162 Mbps for the second signal 32. Thus, the example LAN 40 provides the same coverage area as the prior art LAN 20 without requiring the additional wiring and base stations 24.

Although the example embodiment discloses use of the LAN 14 within an aircraft cabin 10 other environments utilizing a LAN requiring a high signal processing capacity would benefit from the inventive LAN 14, including mass transit trains and office buildings.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A wireless local area network comprising:
a central processing unit;
a plurality of radios each having an antenna and a radio frequency transmitter and receiver wherein the plurality of radios are connected in series to the central processing unit; and
a common radio frequency combiner and splitter connected to the plurality of radios.

2. The network of claim 1, wherein each of the plurality of radios transmits a radio frequency signal different from the radio frequency signal transmitted by the remaining plurality of radios.

3. The network of claim 1, wherein the number of radios included in the plurality of radios corresponds to a number of locations to be connected to the central processing unit.

4. The network of claim 1, wherein the radio frequency combiner and splitter is connected to the plurality of radios in series such that each of the plurality of radios can transmit a radio frequency signal independent from the remaining plurality of radios.

5. The network of claim 1, wherein the central processing unit is connected to the Internet.

6. An aircraft cabin comprising:
a cabin body;
a central processing unit for a wireless local area network located within the cabin body;
a plurality of radios each having a radio frequency transmitter and receiver, wherein each of the plurality of radios are connected to the central processing unit; and
a common radio frequency combiner and splitter connected to the plurality of radios.

7. The aircraft cabin of claim 6, wherein each of the plurality of radios transmits a radio frequency signal different from the radio frequency signal transmitted by the remaining plurality of radios.

8. The aircraft cabin of claim 6, wherein the plurality of radios is determined by a number of locations to be connected to the central processing unit.

9. The aircraft cabin of claim 6, wherein the radio frequency combiner and splitter is connected to the plurality of radios in series such that each of the plurality of radios can transmit a radio frequency signal independent from the remaining plurality of radios.

10. The aircraft cabin of claim 6, wherein the central processing unit is connected to the Internet.

11. A method of connecting a wireless area network comprising:
a) providing a central processing unit;
b) connecting a plurality of radios to the central processing unit; and
c) connecting a common radio frequency combiner and splitter to the plurality of radios such that each radio transmits independently from the remaining plurality of radios.

12. The method of claim 11, wherein said step b) includes determining the number of radios based upon a number of locations to be connected to the central processing unit.

13. The method of claim 11 further comprising:
d) connecting at least one additional radio to the central processing unit and the radio frequency combiner and splitter to increase the data transfer capacity of the network.

14. The method of claim 11, wherein said step a) further comprises connecting the central processing unit to the Internet.

15. The method of claim 11, wherein said step b) includes setting each of the plurality of radios to transmit a different radio frequency signal.
